(19) United States
(12) Patent Application Publication
(10) Pub. No.: US 2010/0309976 A1
(43) Pub. Date: Dec. 9, 2010

(54) METHOD AND APPARATUS FOR ENHANCING REFERENCE FRAME SELECTION

(75) Inventors: Osman G. Sezer, Atlanta, GA (US); Minhua Zhou, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/478,213

(22) Filed: Jun. 4, 2009

(51) Int. Cl. H04N 7/32

(52) U.S. Cl. 375/240.12; 375/E07.243

(57) ABSTRACT

A method and apparatus for selecting a reference frame for producing an encoded image. The method includes retrieving a histogram for a current frame, determining the difference between the histogram and a previous histogram, and calculating adaptive threshold utilizing the determined difference and encoding the frame as intra frame if it is an intra frame, and selecting a reference frame and encoding the frame as non-intra frame if the frame is a non-intra frame.

### BACKGROUND OF THE INVENTION

1. Field of the Invention

Embodiments of the present invention generally relate to a method and apparatus for enhancing reference frame selection.

### BACKGROUND OF THE INVENTION

Most portable devices with video applications require on-chip video encoders that can process video sequences on-the-fly. An acquired image of a scene, which is projected on CCD chip by camera lens, is pre-processed by an Image Signal Processing (ISP) chip before video encoding.

State-of-the-art video coding methods use block-based approaches to compress frames in a video sequence. DCT-based block transforms are easy to implement and, thus, are used frequently in block-based video coding. These block-based methods partition frames into blocks (or macroblocks) of possibly variable sizes. Later, the blocks of the current frame are matched with the previously encoded frames (inter-coding). If appropriate match can be found only the difference is usually encoded. Hence, one is capable of only sending motion vector for the location of matched prediction and transformed difference data with fewer coefficients than original image.

However, when no match is found for a particular block, that block will be encoded by intra-coding. With intra-coding, no relative information from previous frames is used. As a result, such a block will be encoded by its own information. Occurrence of many intra-coded blocks in an inter-coded frame (Inter frame) actually signals a significant change of the content in the video sequence.

Among various kinds of scene changes, a sudden replacement of the current scene by the next scene is called as scene cuts. At a scene cut, two consecutive frames would likely have different content. Therefore, such scenes have totally different coding complexity. This poses a significant problem because there is no coding continuity between consecutive pictures in a scene cut. Disruption of coding continuity disables inter-coding strategy. Consequently, locating scene cuts and using intra coding for the entire image in these cases improves coding efficiency by providing better bit-allocation, saves from redundant computations spent on motion prediction, and overall consumes less overhead.

Traditionally, frame difference information between frames is used to assess presence of a scene cut in the observed data or for reference frame selection. However, there are some disadvantages of such an implementation. First, taking frame differences requires additional computations, and second, sufficient memory-bandwidth is needed to read frames. Moreover, these procedures introduce time-delay to the entire process.

Therefore, there is a need for an improved method and apparatus for detecting scene cuts and reference frame selection.

### SUMMARY OF THE INVENTION

Embodiments of the present invention relate to a method and apparatus for selecting a reference frame for producing an encoded image. The method includes retrieving a histogram for a current frame, determining the difference between the histogram and a previous histogram, and calculating adaptive threshold utilizing the determined difference and encoding the frame as intra frame if it is an intra frame, and selecting a reference frame and encoding the frame as non-intra frame if the frame is a non-intra frame.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In this application, a computer readable processor is any medium accessible by a computer for saving, writing, archiving, executing and/or accessing data. Furthermore, the method described herein may be coupled to a processing unit, wherein said processing unit is capable of performing the method.

FIG. 1 is an embodiment of a block diagram of an encoding system;

FIG. 2A is an embodiment of a graph depicting distance metrics for histogram difference;

FIG. 2A is an embodiment of a graph depicting a frame differentiation;

FIG. 3 is an embodiment of a graph depicting a sequence showing variations;

FIG. 4 is an embodiment of a reference frame selection after a scene cut; and

FIG. 5 is a flow diagram depicting an embodiment of a method for a histogram based module.

### DETAILED DESCRIPTION

The sudden scene changes in video sequences challenge both video quality and bit-rate during video encoding process. If a scene change occurs at a frame that is intended to be coded as an inter frame, most of the macroblocks in that frame will be intra coded which will reduce coding efficiency. Therefore, making a decision for intra frame coding at scene cuts will both save from unnecessary computations done for prediction, in the inter frame coding, and improve visual quality of the encoded video.

Also detecting scene cuts will help to enhance rate-control performance for bit-budget allocations of each frame. Thus, using histograms of current and previous frames to make scene change decision. An adaptive learning method for extraction of statistics has been implemented for statistical outlier detection. Moreover. Utilizing histograms for detecting scene cuts and considering flexible reference frame selection scheme in video codec like H.264, one can select better reference frame for each frame from the previously encoded K frames using correlations between histograms.

Single-frame scene changes are considered as a clear example to study the effect of histogram-based reference frame selection. To describe briefly, there are cases when the continuity of the content of a video can be disturbed by a single frame such as sudden burst of a nearby camera's flash. Detection of these frames plays important role for reference frame selection. An improved histogram-based cost function is utilized to determine a better reference frame among the previously encoded frames. Combined with scene cut detection algorithm, reference frame assessment can help video coder to reduce compression artifacts.

Locating scene cuts and using intra coding for the entire image improves coding efficiency by providing better bit-allocation, saves from redundant computations spent on block matching and consumes less overhead. In order to increase coding efficiency, the reference frame selection is a key element, for example in H.264-like video encoders, because it provides the flexibility to use previous frames as the reference frame candidates. Such property of the codec may be utilized in deciding whether a scene-cut frame is the best choice to be a reference frame for the trailing frames. Moreover, such a method may assist the encoder to differentiate whether a scene cut introduces a new and continuous video content or it is just observed in a single frame like the burst of a nearby camera's flash affecting a single frame. Thus, a histogram-based, low-complexity scene cut detection (SCD) algorithm is used to indicate scene cuts to the video encoder before encoding the current frame and an enhanced algorithm may be used for reference frame selection.

In video cameras, acquired image of a scene is projected on CCD chip by camera lens and through a pre-processing done by an Image Signal Processing (ISP) chip before video encoding step. Thus, incorporating readily available data from ISP chip for video encoder improves visual quality of encoded video sequence by signaling scene cut information.

ISP chip extracts and uses image histogram information for pre-processing image data, for example, Gamma correction. The image histograms from ISP chips can be used to determine existence of a scene cut in the current frame before it is encoded. Frame difference between consecutive frames may be used for SCD decision; however, utilizing frame difference requires extra computational power and extra memory-bandwidth resources for loading current and previous frames. Since the dimensionality of the image histograms is much smaller than the frame size, a histogram-based method will not have these restrictions.

As such, described herein is an on-the-fly, adaptive, and low-complexity scene change detection algorithm which uses image histograms of the current and previous frames and a robust scene change detection that utilizes weighting channel histograms. Hence, one embodiment utilizes histograms of frames to select a new reference frame. One embodiment incorporates an adaptive thresholding mechanism that detects statistical outliers in the observations.

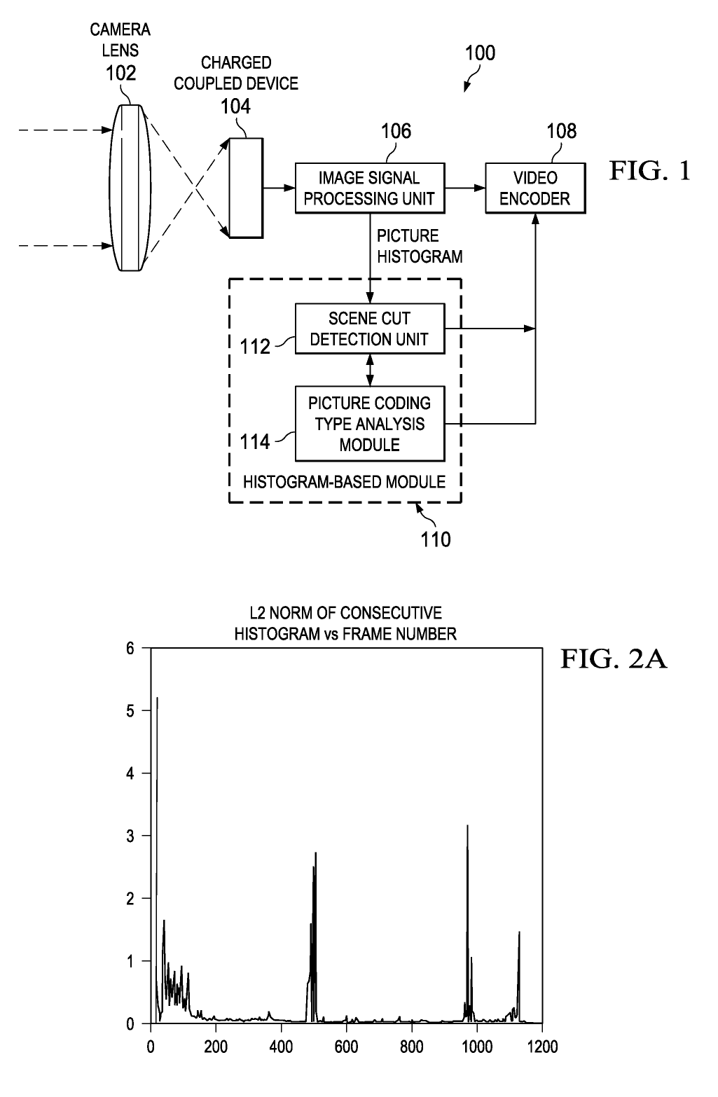

FIG. 1 is an embodiment of a block diagram of an encoding system 100. The method includes a camera lens 102, a charged coupled device 104 104, an Image signal Processing (ISP) 106, a video encoder 108, and a histogram-based module 110. The histogram-based module 110 includes a scene cut detection (SCD) unit 112 and a picture coding type analysis (PCT) module 114.

Image projected on a CCD chip by a camera lens 102 goes first to ISP 106 for pre-processing. Usually, only Inter frame coding type is P. ISP 106 outputs two data types. First one the pre-processes image that is sent to video encoder 108 and the histograms of that image that go to SCD 112. These histograms can be Luminance, chrominance or color histograms. Histograms are combined in histogram-based module 110, where a new histogram is created.

Next, SCD 112 measures the distance between current and previous histograms. This distance is added to the previously found histogram distance. A threshold value is calculated by an update mechanism and compared against the current measurement. If current measurement exceeds the threshold value, scene cut will be detected and depending on the current encoding settings either that frame will be coded as Intra frame (I-frame) or will remain as it is (as a I- or P-frame). The method of the histogram-based module will be discussed in details in FIG. 5.

The first step is to create a new feature vector that can best represent variations in the image. A histogram essentially shows the number of occurrences of intensity values in a given image. The ISP 106 can provide histograms of different color and illumination component of the observed scene; thus, this utilizes a new weighted histogram feature that combines different characteristics of these channels for SCD problem. For instance, scene changes that include illumination changes can be detected by using Luminance component (Y). However, if a scene cut has dominant color changes rather than illumination, using just histogram of Luminance will not suffice. Thus, following weighting scheme is proposed as a new feature vector for the observed images

$$Weighted\_Hist = {\sum }_{i ε \{ 0 , … , M - 1 \}} {\sum }_{Channel = 0}^{K} {Hist}_{Channel} [ i ] . \qquad ( 1 )$$

where K is the number of channels (luminance, chrominance, color etc.) and M is the number of bin for the histograms. Throughout the document, a histogram is a histogram obtained utilizing Eq. (1).

Next is determining the distance metric that enables robust differentiation between histograms. There are three possible distance metrics that can be used to measure difference between histograms. These metrics are Correlation Coefficient (CC), Sum of Absolute Differences (SAD) and Sum of Squared Differences SSD. For two vector v₁ and v₂, these metrics can be written as

$$Correlation Coefficient ( C C ) {=}^{△} \frac{{\vec{v}}_{1} \cdot {\vec{v}}_{2}}{{‖ {\vec{v}}_{1} ‖}_{2} \cdot {‖ {\vec{v}}_{2} ‖}_{2}}$$

$$S A D {=}^{△} {\sum }_{i} \vert {\vec{v}}_{1} ( i ) - {\vec{v}}_{2} ( i ) \vert$$

$$S S D {=}^{△} {( {\sum }_{i} {( {\vec{v}}_{1} ( i ) - {\vec{v}}_{2} ( i ) )}^{2} )}^{1 / 2} .$$

SSD between histograms of consecutive frames exhibits more stable statistical characteristics than any other candidate distance metrics. If each histogram is defined as a vector in M dimensional space where M is the number of bins, we have the following formulation as the distance metric between two histograms,

$$Hist\_curr \text{:} Histogram of current frame \\ Hist\_prev \text{:} Histogram of previous frame \\ Dist ( a , b ) \text{:} S S D between vectors a and b . \\ Dist ( Hist\_curr , Hist\_prev ) {=}^{△} {( \begin{matrix}{\sum }_{i ε \{ 0 , … , M - 1 \}} \\ {( \begin{matrix}Hist\_curr ( i ) - \\ Hist\_prev ( i )\end{matrix} )}^{2}\end{matrix} )}^{1 / 2} \qquad ( 2 )$$

In one embodiment, a new measure for scene cut is defined as the absolute difference between consecutive histogram distances. This metric, called ‘Change’ measures the accumulated variations observed in consecutive histogram distances. The metric is defined as,
Change(k): Metric that measures the dissimilarity between current frame and previous N frames.
Hist[k]: Histogram of kth frame
Dist(a,b): Euclidean Distance between vectors a and b.

$$Change ( k ) {=}^{△} {\sum }_{l = 0}^{N} \vert \begin{matrix}Dist ( \begin{matrix}Hist [ k - l ] , \\ Hist [ k - l - 1 ]\end{matrix} ) - \\ Dist ( \begin{matrix}Hist [ k - l - 1 ] , \\ Hist [ k - l - 2 ]\end{matrix} )\end{matrix} \vert . \qquad ( 3 )$$

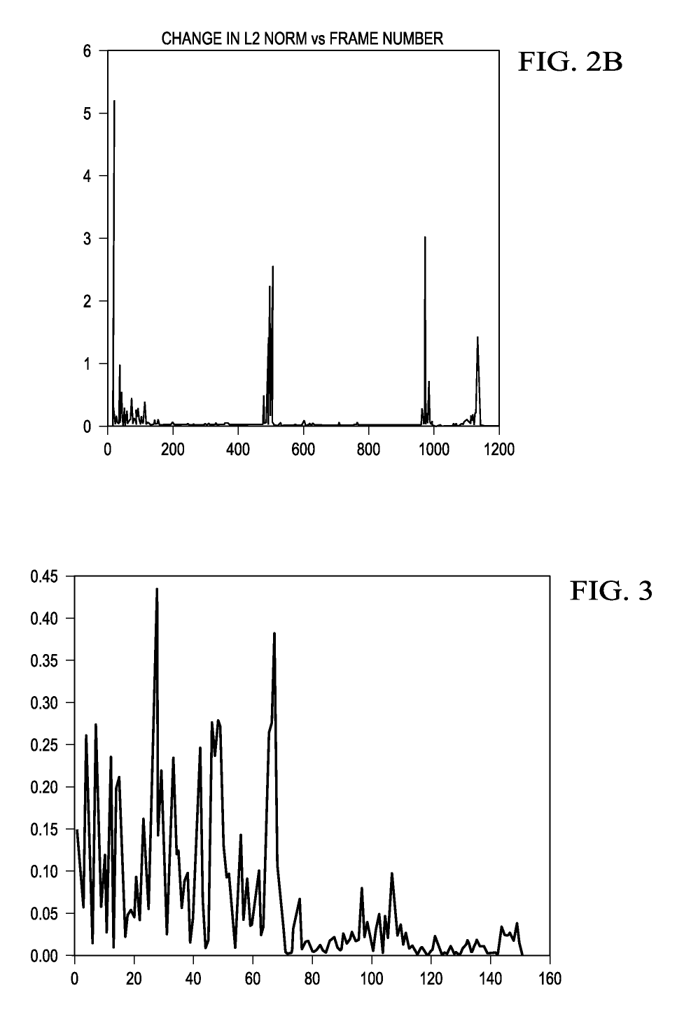

In one embodiment, histograms are normalized to have unit sum. Shown in FIG. 2A is the distance between consecutive histograms measured by Eq. (1) and in FIG. 2B the measure ‘Change’ (Eq. (3)) in sequence dlp_{—}352x288_cif.yuv. As shown in the FIG. 2A and B, the variation within the first 200 frames is reduced by using ‘Change’ metric. Also it is important to note that in the beginning of coding first N frames have to arrive before a SCD can be signaled to the encoder. Therefore, choice of N should be small. In this embodiment, N is set to five (5) and the results are reasonable.

After measuring the dissimilarity between consecutive frames, the threshold is utilized to separate scene cuts from regular flow of video content. Therefore, having a statistical stable metric for frame differentiation makes sense. Nevertheless, applying a fix threshold usually may not work. In one embodiment, adaptive threshold is utilized that is drawn from learned statistics of the Change metric. It should be noted that any metric may be utilized. Therefore, SAD, CC, SSD or any difference metric between frames or histograms may be used to locate scene change by the following adaptive threshold.

Decision for a scene cut for the i'th frame can be given as follows;

$$Label ( i ) = \qquad \{ \begin{matrix}1 & Change ( i ) > {μ}_{i} + k \cdot {σ}_{i} \\ 0 & otherwise\end{matrix}$$

where label ‘1’ denotes scene change at that frame. μᵢ can be called as the moving average of measured observations before i'th frame. Similarly, σᵢ is the moving standard deviation (or variance). Here, k defines the confidence interval. Adaptation of the threshold value is accomplished by a simple update procedure for moving average and moving variance. The update is controlled by a parameter such that the rate of adaptation of threshold to the observations is managed. This kind of schemes that permit learning and forgetting rates under control can be implemented as follows:

μᵢ=(1−αᵢ)μᵢ₋₁−αᵢ.Change(i−1) (4)

σᵢ²=(1−αᵢ)σᵢ₋₁²+αᵢ.(Change(i−1)−μᵢ)²

where αᵢ is called learning rate. Learning rate can either be selected as a fixed number or it can be made adaptive too as given,

αᵢ=η(Change(i)|μᵢ₋₁,σᵢ₋₁) (5)

for η is a Gaussian distribution for given mean and variance,

$$η ( x \vert {μ}_{x} , {σ}_{x} ) = \frac{1}{\sqrt{2 π} {σ}_{x}} {e}^{- \frac{1}{2 {σ}_{x}^{2}} {( x - {μ}_{x} )}^{2}} . \qquad ( 6 )$$

The advantage of having adaptive learning rate is the ability to control the effect of outlier observations to the moving average and variance adaptively. For instance, occurrence of outlier values would be less likely. Thus, learning rate, α, will have small value. Small α value affects the update mechanism of Eq. 4.

Note that in such a case the current observation (i.e, Change(i)) will have less influence on moving average and moving variance. On the other hand, if two many outliers are detected successively; these values pull up the moving average which actually signals a change in statistics of observations. Essentially, a small α value slow downs the adaptation of threshold. Hence, the threshold learns and forgets the observations slowly. On the contrarily, threshold adapts faster to the observation if α value is large.

The choice of using an adaptive learning rate and N value in Eq. (3) has a close relation. If N is greater than one, a scene change will affect subsequent observations of the defined measure in Eq. (3) while the threshold will remain unchanged and a false detection would occur. Therefore, if adaptive learning rate is used, N has to be kept one (1). On the other hand, in some applications evaluating Eq. (5) or keeping a look-up table for that would be undesirable, in such cases, learning level can be fixed to a value between zero (0) to one (1). Adaptation gets faster as learning rate gets close to one. In our experiments, we adopt 0.6 as the learning rate of the algorithm for such cases.

Another consideration that we addressed is to limit the number of consecutive Intra frames. Having a cluster of consecutive Intra frames would increase bit-rate, thus we have a limit on the number of consecutive frames labeled as scene cut. This can be accomplished by enforcing addition constraint to have a single scene cut in L frames; the equation follows as,

$$\begin{matrix}Label ( i ) = & \{ \begin{matrix}1 & Change ( i ) > {μ}_{i} + k \cdot {σ}_{i} \& {\sum }_{k = i - L}^{i - L} Label ( k ) = 0 \\ 0 & otherwise\end{matrix}\end{matrix} \qquad ( 6 )$$

In case of a static scene, where nothing much changes in the content, the proposed metric Change will tend to become zero (0) as time goes on. Therefore, even a subtle change in color or illumination may be detected as scene cut. This is because the threshold value (μᵢ+k.σᵢ) approaches to zero (0). In order to reduce such false detections, a bottom limit for Change metric is used in this work. This bottom limit, which can be called as limiting threshold (Tₗᵢₘ), is a constant obtained by experimental observations. In our experiments, Tₗᵢₘ is set to 0.01*N where N is defined in Eq. (3). Final decision is given according to the following formulation,

$$\begin{matrix}Label ( i ) = & \{ \begin{matrix}1 & Change ( i ) > {μ}_{i} + k \cdot {σ}_{i} \& Change ( i ) > {T}_{lim} \& {\sum }_{k = i - L}^{i - L} Label ( k ) = 0 \\ 0 & otherwise\end{matrix}\end{matrix} \qquad ( 7 )$$

There are many disadvantages to use just image histograms for making SCD decision. Primarily, one can find two totally different images that have very similar histogram. Moreover, even if the content of two images is the same, changes in global or local illumination might hinder an accurate SCD decision. Detecting scene changes created artificially by fade-ins and fade-outs; also, it brings challenges due to smooth transitions between consecutive histograms. Although these issues pose a difficult problem in general, the proposed method provides the detection performance for a video quality improvement.

Another important factor that affects video coding quality is the selection of reference frame, i.e. in for H.264-like video coders, that provide such flexibility. The proposed solution for determining best reference frame among the previously encoded frames uses frame histograms. General case of locating reference frame is explained by single-frame scene cut example. Locating a single-frame scene cut before encoding by the SCD algorithm solves the first part of video coding efficiency problem by encoding that frame as an I-frame for given bit-allocation. However, the next frame following the scene cut will have less correlation with the frame labeled as scene cut than the ones preceding it.

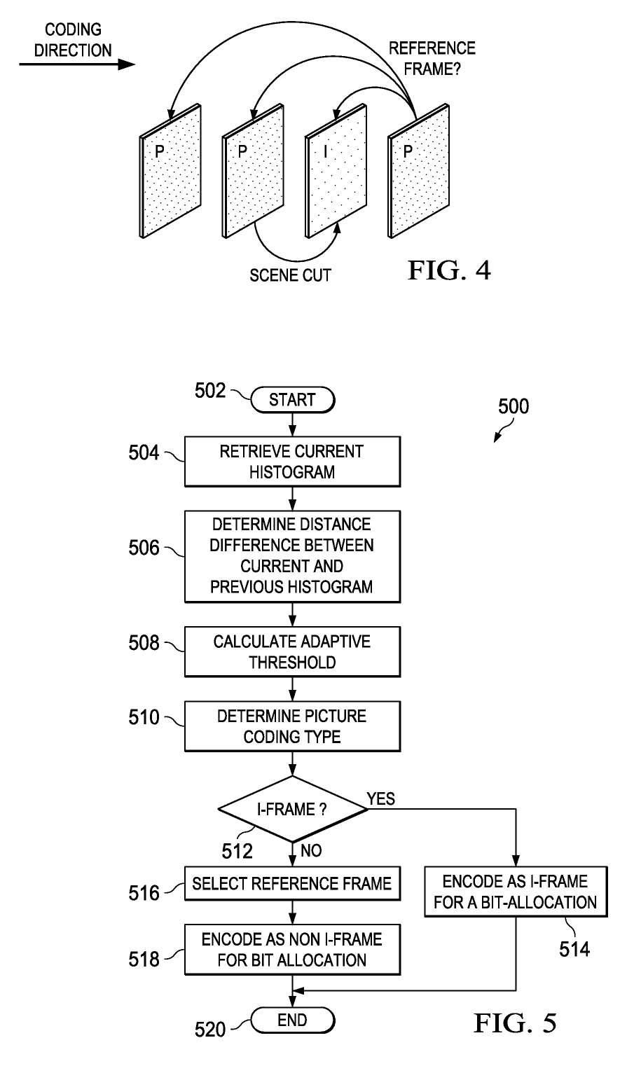

FIG. 4 is an embodiment of a reference frame selection after a scene cut. FIG. 4 shows such a case when illumination changes just in one frame with a close by camera's flash. In this case, only scene cut frame disturbs the continuity of video coding. Fortunately, H.264-like video coding strategies enable one to control the reference frame for the current frame. Therefore, intra-coded scene cut frame are not required as the reference frame for the frames trailing it. Note in the FIG. 4 after scene cut frame, we do not detect another scene cut because of the limit in Eq. (6) and Eq. (7) for the number of consecutive scene cuts.

FIG. 5 is a flow diagram depicting an embodiment of a method 500 for a histogram based module. The method 500 starts at step 502 and proceeds to step 504. At step 504, the method 500 retrieves a current histogram. At step 506, the method 500 determines the distance difference between the current histogram and the previous histogram. At step 508, the method 500 calculates the adaptive threshold. At step 510, the method 500 determines the picture coding type. At step 512, the method 500 determines if the frame is an Intra frame (I-frame). If the frame is an I-frame, the method 500 proceeds to step 514, wherein the method 500 encodes it as an I-frame for bit-allocation. Otherwise, the method 500 proceeds to step 516. At step 516, the method 500 selected a reference frame and proceeds to step 518. At step 518, the method 500 encodes the frame as a non I-frame. From steps 514 and 518, the method 500 proceeds and ends at step 516.

Since the proposed method and apparatus use image histograms that may be from ISP chip and since histogram has much smaller dimensionality compared to a frame, the proposed method and apparatus are low in complexity and do not introduce delay. Consequently, a fast, on-the-fly decision about the existence of a scene cut and reference frame selection for the current frame is made, without using extra memory-bandwidth.

While the foregoing is directed to embodiments of the present invention, other and further embodiments of the invention may be devised without departing from the basic scope thereof, and the scope thereof is determined by the claims that follow.

What is claimed is:

1. A method for selecting a reference frame for producing an encoded image, comprising
retrieving a histogram for a current frame;
determining the difference between the histogram and a previous histogram; and
calculating adaptive threshold utilizing the determined difference and encoding the frame as intra frame if it is an intra frame, and selecting a reference frame and encoding the frame as non-intra frame if the frame is a non-intra frame.

2. The method of claim 1, wherein the threshold is determined by an adaptive thresholding mechanism that detects statistical outliers in the observations.

3. A apparatus for selecting a reference frame for producing an encoded image, comprising:
means for retrieving a histogram for a current frame;
means for determining the difference between the histogram and a previous histogram; and
means for calculating adaptive threshold utilizing the determined difference and means for encoding the frame as intra frame if it is an intra frame, and means for selecting a reference frame and means for encoding the frame as non-intra frame if the frame is a non-intra frame.

4. The apparatus of claim 3, wherein the threshold is determined by an adaptive thresholding mechanism that detects statistical outliers in the observations.
